(19) United States
(12) Patent Application Publication
(10) Pub. No.: US 2021/0092647 A1
(43) Pub. Date: Mar. 25, 2021

(54) METHOD AND SYSTEM FOR DYNAMICALLY CONFIGURABLE CONTROL NODE

(71) Applicant: Verizon Patent and Licensing Inc., Arlington, VA (US)

(72) Inventors: Jin Yang, Orinda, CA (US); Kalyani Bogineni, Hillsborough, NJ (US); Sudhakar Reddy Patil, Flower Mound, TX (US); Gerardo S. Libunao, Manalapan, NJ (US)

(21) Appl. No.: 16/578,726

(22) Filed: Sep. 23, 2019

(51) Int. Cl. H04W 28/24; H04W 28/26; H04W 76/10

(52) U.S. Cl. CPC H04W 28/24; H04W 88/085; H04W 76/10; H04W 28/26

(57) ABSTRACT

A device receives a message requesting establishment of packet data unit (PDU) session for an end device and determines that the message identifies particular performance requirements relating to the requested PDU session. The device initiates dynamic instantiation of one or more functional components at a configurable control node based on the particular performance requirements. The device then establishes the PDU session using the dynamically instantiated of one or more functional components.

### BACKGROUND

Mobile communications may involve mobile user equipment, such as mobile devices and data terminals. Long Term Evolution (LTE) networks may include existing Fourth Generation (4G), and 4.5 Generation (4.5G) wireless networks. The goals of LTE have included increasing the capacity and speed of wireless data networks and redesigning and simplifying the network architecture to include an Internet Protocol (IP)-based system with reduced latency.

Next Generation mobile networks have been proposed as the next evolution of mobile wireless networks. Next Generation mobile networks, such as Fifth Generation New Radio (5G NR) mobile networks, are expected to operate in the higher frequency ranges (e.g., in the GigaHertz frequency band) with a broad bandwidth near about 500-1,000 MegaHertz. The expected bandwidth of Next Generation mobile networks is intended to support higher speed downloads and data throughput. 5G mobile telecommunications may operate in the millimeter wave bands (e.g., about 14 GigaHertz (GHz) and higher), and may support more reliable, massive machine communications (e.g., machine-to-machine (M2M), Internet of Things (IoT)). Next Generation mobile networks, such as those implementing the 5G mobile telecommunications standard, are expected to enable a higher utilization capacity than current wireless systems, permitting a greater density of wireless users. Next Generation mobile networks are being designed to increase data transfer rates, increase spectral efficiency, improve coverage, improve capacity, and reduce latency.

“Network Slicing” is an innovation for implementation in Next Generation Mobile Networks, such as 5G mobile networks. Network slicing is a type of virtualized networking architecture that involves partitioning of a single physical network into multiple virtual networks. The partitions, or “slices,” of the virtualized network may be customized to meet the specific needs of applications, services, devices, customers, or operators. Each network slice can have its own architecture, provisioning management, and security that supports a particular application or service. Speed, capacity, and connectivity functions are allocated within each network slice to meet specific operational requirements. Network slicing may be implemented in a dynamic fashion, such that the network slices may change over time and may be re-customized to meet new or changing needs of applications, services, devices, customers, or operators.

Development and design of radio access networks (RANs) present certain challenges from a network-side perspective and an end device perspective. To enhance performance, network configurations are being explored in which network capabilities are situated at the network edge to reduce latency and security and to reduce traffic being sent to the core network.

### BRIEF DESCRIPTION OF THE DRAWINGS

FIG. 1 illustrates an exemplary configurable control node in an exemplary wireless station of a wireless network;

FIG. 2 illustrates an example of multiple different distributed locations, within a network environment, at which configurable control nodes may be installed to handle traffic from different applications or different network services that require different levels of network performance;

FIG. 3 is a diagram of an exemplary embodiment of a configurable control node consistent with embodiments described herein;

FIGS. 4A and 4B illustrate examples of self-organizing networks that may be implemented in the network environment of FIG. 2;

FIG. 5 is a diagram of exemplary components of a device that may execute functions of a configurable control node, a centralized unit, a distributed unit, or a radio unit;

FIG. 6 shows a signal flow diagram that depicts exemplary interactions between components of the network environment of FIG. 2; and

FIG. 7 is a flow diagrams of an exemplary process for dynamically configuring network control plane functions based on, for example, network performance requirements of a particular user equipment application.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

The evolution of mobile networks, such as Next Generation radio networks, towards Open Radio Access Networks (RANs) and virtualized RANs has gained momentum. Open RANs have the ability to integrate, deploy, and operate RANs using elements (e.g., components, subsystems, and software) which are sourced from multiple different vendors, are inter-operable, and can connect over open interfaces. Virtualized RANs involve the use of Network Functions Virtualization (NFV) and Software Defined Networks (SDNs) to virtualize a portion of the RAN onto standard Information Technology (IT) and Commercial Off-the-Shelf (COTS) hardware in a central location or in the cloud. Virtualized RANs offer a number advantages, including a flexible and scalable architecture that enables dynamic load-balancing, intelligent traffic steering, and latency reduction using local caching.

Next Generation mobile networks, through the use of network slicing, for example, may be designed to offer a variety of services that each demands a different network performance for different types of transport sessions. Exemplary embodiments described herein implement a dynamically configurable control node that integrates radio and control plane functionality, to, in conjunction with multiple network distributed User Plane (UP) functions, enable the flexible routing and transport of traffic to satisfy different QoS and network slicing requirements associated with different types of network services and different types of traffic. Such configurable nodes may be configured based on user equipment (UE) requested requirements (i.e., security and/or latency requirements) as well as the availability of such configurable resources. The configurable control nodes may be positioned, using, for example, NFV, at different distributed locations throughout the network environment, such as at the far edge (e.g., wireless node), in an edge cloud (e.g., a Multi-Access Edge Computing (MEC) cloud), in a centralized RAN (C-RAN), and/or in the core cloud.

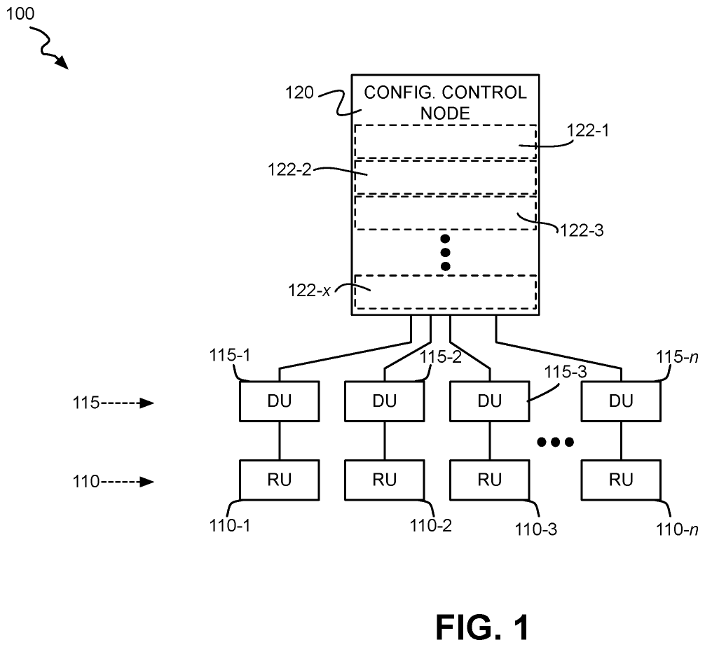

FIG. 1 illustrates an exemplary configurable node in an exemplary wireless station 100 of a wireless network (not shown). The wireless station (also referred to as “base station”) 100 may, in one implementation, include a New Radio (NR) Next Generation gNodeB used in the Radio Access Network (RAN) of a Next Generation mobile network, such as, for example, a 5G mobile network. Base station 100 may include at least one radio unit (RU) 110, at least one distributed unit (DU) 115, and at least one configurable control node 120.

RU 110 may include multiple RUs 110-1 through 110-n. Each RU 110 may include at least one radio transceiver and associated antenna(s), for RF wireless communication with one or more user equipment (UEs) (not shown). Each RU 110 includes a logical node that hosts functions associated with the physical layer (PHY). UEs, as referred to herein, may include any type of electronic device having a wireless capability (e.g., a RF transceiver) to communicate with the wireless network via a wireless station 100. Each of the UEs may include, for example, a mobile phone or “smartphone,” a computer (e.g., desktop, laptop, tablet, or wearable computer), or a “Machine-to-Machine” (M2M) or “Internet of Things” (IoT) device. A “user” (not shown) may own, operate, and/or administer each UE. UEs may also be referred to as “end devices” in some implementations.

DU 115 of wireless station 100 may, in some implementations, include multiple DUs 115-1 through 115-n, where n is equal to or greater than 2. Each DU 115 includes a logical node that hosts functions associated with the Radio Link Control (RLC) layer and the Media Access Control (MAC) layer. Each DU 115 connects to a RU 110 (i.e., each of DUs 110-1 through 110-n connects to a respective one of RUs 115-1 through 115-n. In some instances, the term “DU” may be interpreted as including both the DU 115 and RU 110.

As shown in FIG. 1, configurable control node 120 may include a number of configurable elements, denoted as node sub-elements 122-1 to 122-x. Depending on requested capabilities and available resources (e.g., physical resources), sub-elements 122 may be dynamically configured to include one or more Central Unit (CU) functionalities, Access and mobility Management Function (AMF) functionalities, or Session Management Function (SMF) functionalities. Once instantiated to include particular requested functionalities, data traffic to/from UEs may leverage the functionalities to increase performance and/or security during particular data sessions. Instantiation or selection of a particular control node functionality based on, for example, a performance profile associated with the DU 115, a user profile associated with the requesting UE, and/or network performance requirements associated with the network service, application, or traffic involved in the data session.

CU functionalities may be configured to control the transport of data (e.g., data packets) received at a RU 110 via wireless RF transmissions from a UE (not shown) and control the transport of data from the wireless network to a DU 115 and RU 110, for wireless transmission to a destination UE (not shown). CU functionalities may be divided as CU-Control Plane (CP) (referred to herein as “CU-CP”) functionalities and a CU-User Plane (UP) (referred to herein as “CU-UP”) functionalities. CU-CP functionalities may define a logical node that hosts Radio Resource Control (RRC) layer, Packet Data Convergence Protocol (PDCP)) layer, and other control plane functions. The CU-UP functionalities may define a logical node that hosts user plane functions, such as, for example, data routing and transport functions. As described in further detail below, the CU-CP and/or CU-UP may include distributed nodes that may be located remotely from one another, depending on configuration and performance requirements.

AMF functionalities may be configured to perform registration management (RM), connection management (CM), reachability management, mobility management, lawful intercepts, Short Message Service (SMS) transport, session management message transport, access authentication and authorization (e.g., integrity protection, ciphering), location services management, functionality to support non-3GPP access networks, and/or other types of management processes using the Non-Access Stratum mobility management (NAS-MM) protocol.

SMF functionalities may be configured to perform session establishment, session modification, and/or session release, perform IP address allocation and management, perform Dynamic Host Configuration Protocol (DHCP) functions, such as assigning end device IP addresses, perform selection and control of user plane function (UPF) components, configure traffic steering to guide the traffic to the correct destinations, perform lawful intercepts, charge data collection, support charging interfaces, control and coordinate of charging data collection, terminate session management parts of Non-Access Stratum (NAS) messages, perform downlink data notification, manage roaming functionality, and/or perform other types of control plane processes for managing user plane data using the NAS session management (NAS-SM) protocol.

The NAS-SM protocol supports UP PDU session establishment, modification and release. NAS-SM signaling messages are transferred via the AMF to SMF in a transparent way, without modification by intervening RAN devices (e.g., RU 110, DU 115, etc.). The SMF is responsible for checking whether the UE requests are compliant with the subscription. For example, the SMF may check the PDU session type, QoS information and allowed SSC (Session and Service Continuity) modes, etc.

As further described below, multiple distributed CU, AMF, and/or SMF functionalities may be positioned or dynamically instantiated (e.g., within configurable control node(s) 120) at different locations within a network (not shown) and used to perform access and session management for handling traffic from one or more UEs (not shown). When the requesting UE no longer has a need for the particular function, such configurable functionalities may be torn down or re-allocated.

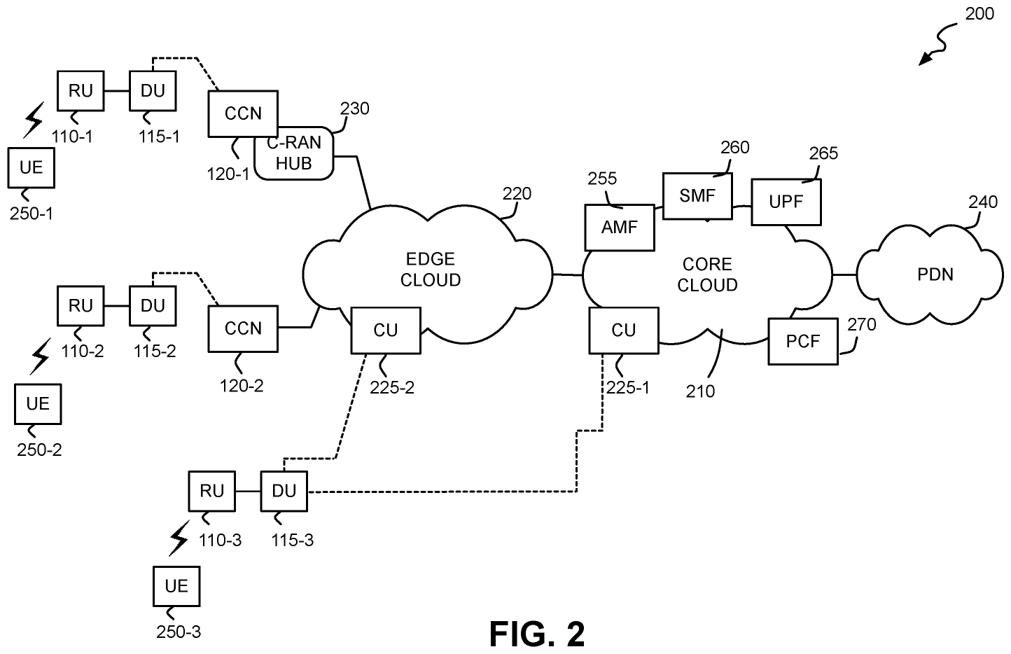

FIG. 2 illustrates examples of different distributed locations within a network environment 200 at which configurable control nodes 120 may be installed to handle control plane traffic from different applications, or different network services, that require different levels of network performance (e.g., different levels of latency sensitivity, security, or bandwidth). Network environment 200 may include, for example, a core cloud 210, an edge cloud 220, a centralized Radio Access Network (C-RAN) hub 230, and a packet data network (PDN) 240. In other implementations, network environment 200 may include a different composition and/or configuration of inter-connected networks. For example, though only a single edge cloud 220 is shown in FIG. 2, network environment 200 may include multiple edge clouds 220 connected to core cloud 210 and/or PDN 240.

Core cloud 210 includes the core components of a wireless network that provides wireless access to subscribing UEs 250. The wireless network may include any type of wireless network that provides wireless access and connectivity to UEs. The wireless network may include, for example, a Public Land Mobile Network (PLMN) or a satellite network. In the case of a 5G wireless network, the core components may include, among other components, one or more core CUs 225-1, a core AMF 255, a core SMF 260, and core-implemented user plane functions (UPF) 265 and policy control functions (PCF). In the cases of other types of wireless networks, core cloud 210 may include other core components (e.g., 4G core components).

Similar to the CU functionalities described above in connection with configurable control nodes 120, core CU 225-1 likewise supports CU-CP and CU-UP. Similar to the possible AMF functionalities of configurable control node 120, core AMF 255 may perform core network-based registration management, connection management, reachability management, mobility management, lawful intercepts, session management messages transport between UE device 250 and core SMF 260, access authentication and authorization, location services management, functionality to support non-3GPP access networks, and/or other types of management processes. Core AMF 255 terminates NAS signaling relating to mobility management from UE 250.

Similar to the possible SMF functionalities of configurable control node 120, core SMF 260 may perform session establishment, session modification, and/or session release, perform IP address allocation and management, perform Dynamic Host Configuration Protocol (DHCP) functions, perform selection and control of UPF 265, configure traffic steering at UPF 265 to guide the traffic to the correct destinations, terminate interfaces toward PCF 270, perform lawful intercepts, charge data collection, support charging interfaces, control and coordinate charging data collection, terminate session management parts of NAS messages, perform downlink data notification, manage roaming functionality, and/or perform other types of control plane processes for managing user plane data. Core SMF 260 terminates NAS signaling relating to session management from UE 250.

UPF 265 may maintain an anchor point for intra/inter-RAT mobility, maintain an external Packet Data Unit (PDU) point of interconnect to a particular data network 140, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to RU 110/DU 115, and/or perform other types of user plane processes.

Edge cloud 220 includes one or more edge computing data centers, or other edge devices, that enable the movement of traffic and network services from core cloud 210 towards the edge of network environment 200 and closer to the destination devices (e.g., UEs 250). Instead of sending data to core cloud 210 for processing, routing, and transport, edge cloud 220 handles the data closer to the destination devices, thereby reducing latency. Edge cloud 220 may include, for example, one or more Multi-Access Edge Computing (MEC) network(s). In addition, although not illustrated in FIG. 2, edge cloud 220 may include additional instances of CU 225, AMF 255, SMF 260, and/or UPF 265. Furthermore, edge cloud 220 may connect to PDN 240 in addition to connecting to core cloud 210.

C-RAN hub 230 may include a centralized office “hotel” at which multiple CU-CPs 120 are located to enable efficient and cost-effective network access. C-RAN hub 230 may connect to edge cloud 220 as shown in FIG. 2, or, in other implementations, may connect to core cloud 210 and/or to PDN 240.

PDN 240 may include any type of packet-switching network(s) that can connect to core cloud 210 for transporting data to and from nodes that are external to core cloud 210. PDN 240 may include, for example, the Internet, a local area network(s) (LAN), a wide area network(s) (WAN), or a metropolitan area network (MAN). In one example, one or more servers may be connected to PDN 240 and may engage in data transport with a UE 250 via PDN 240 and core cloud 210.

As shown in FIG. 2, configurable control nodes (CCNs) 120 may be dynamically positioned at various locations within network environment 200 and may be configured based on, among other factors, the different network performance requirements (e.g., latency and/or security requirements) of the particular applications being executed at the UEs 250. For example, configurable control node 120-1 is located at C-RAN hub 230, and may include instantiations of CU, AMF, and UPF to meet a request from UE 250-1 corresponding to a particular network slice. In another example, as shown in FIG. 2, configurable control node 120-2 is located between edge cloud 220 and DU 115-2 (e.g., co-located, or physically integrated with DU 115-2), and may include additional instantiations of CU, AMF, and UPF.

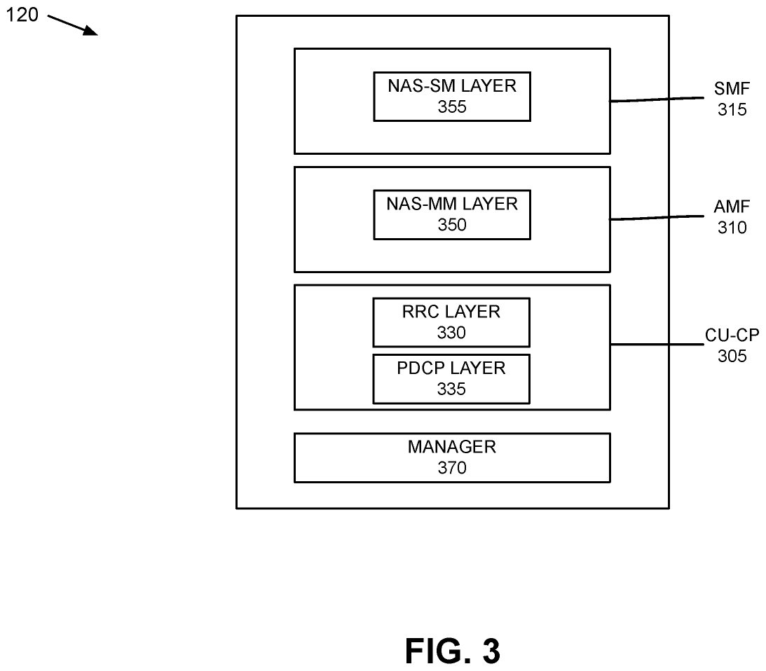

FIG. 3 is a diagram of an exemplary embodiment of configurable control node 120 consistent with embodiments described herein. As shown, configurable control node 120 includes CU-CP logic 305, AMF logic 310, SMF logic 315, and manager 370. CU-CP logic 305 includes RRC layer logic 330 and PDCP layer logic 335. AMF logic includes NAS-MM layer logic 350. SMF logic includes NAS-SM layer logic 355. Although not illustrated, CU-CP logic 305, AMF logic 310, and SMF logic 315 may include other logic or layers for the control plane. For example, CU-CP logic 305 and AMF logic 310 may include layer 1 logic, layer 2 logic, Internet Protocol (IP) layer logic, stream control transmission protocol (SCTP) layer logic, next generation application protocol (NG-AP) layer logic, and/or other control plane logic. In addition, in some embodiments, configurable control node 120 may include additional logic components, such as CU-UP logic, Unified Data Management (UDM) logic, User Plane Function (UPF) logic, etc. or other network function logic corresponding to functions traditionally configured to reside on core network 210. As further illustrated, configurable control node 120 may include a manager 370. Manager 370 may include logic that receives configuration information from, for example, a distributed unit 115 via an F1-C interface. Configuration information may include control-plane functionalities invocation instructions for establishing and management configurable control plane functionalities, as described herein.

Consistent with implementations described herein, each configurable control node may be invoked to dynamically instantiate one or more control plane functionalities corresponding to components that traditionally reside in core network 210 or edge network 220, such as AMF-related functionalities and/or SMF-related functionalities. In this manner, security and latency for such control plane functions may be significantly increased.

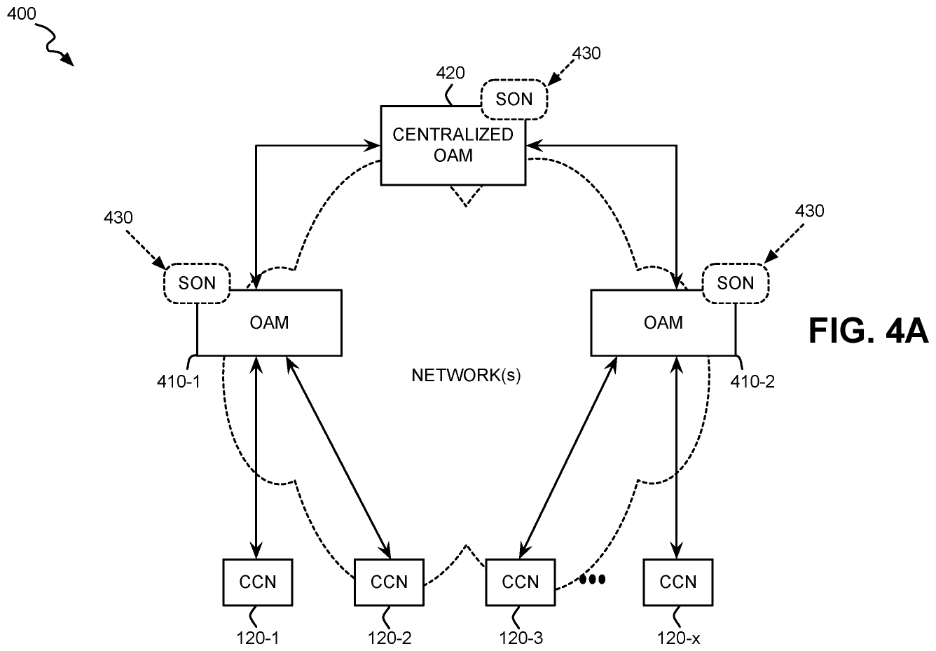

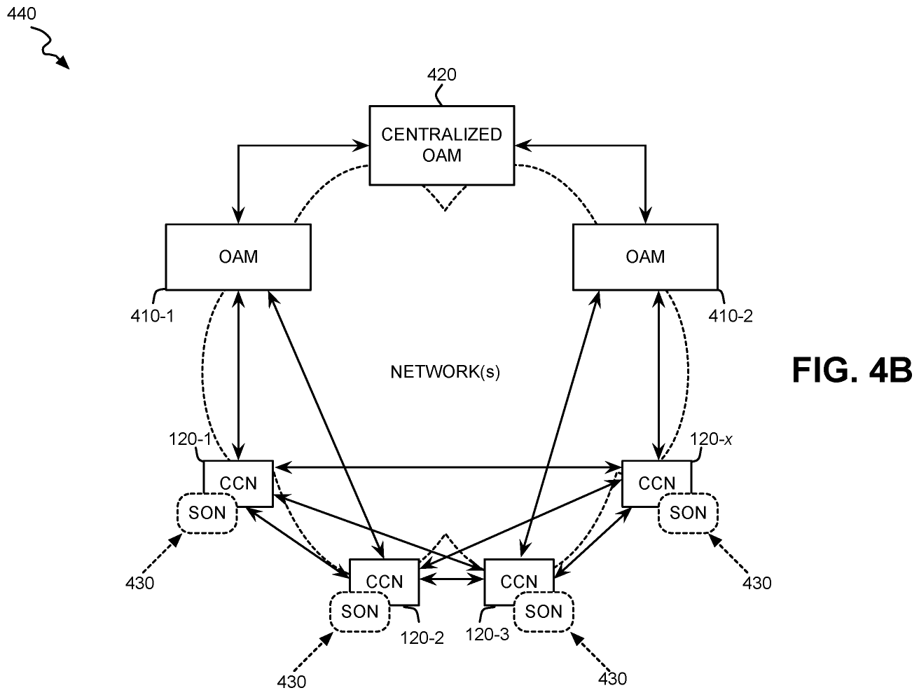

FIGS. 4A and 4B illustrate examples of self-organizing networks (SONs) that may be implemented in the network environment 200 of FIG. 2. As used herein, the term SON refers to an automated system that configures, manages, optimizes, and heals mobile RANs dynamically. SONs may be arranged in various types of configurations including, for example, centralized SONs (cSONs), middle-tier SONs (mSONs), and distributed SONs (dSONs). FIG. 4A depicts an example of a cSON 400 that incorporates configurable control nodes 120 of the network environment 200 of FIG. 2, and FIG. 4B depicts an example of a dSON 440 that also incorporates CU-CPs 120 of the network environment 200 of FIG. 2.

As shown in FIG. 4A, cSON 400 includes configurable control nodes 120-1 through 120-x, Operations, Administration, and Maintenance (OAM) nodes 410-1 and 410-2, and a centralized OAM node 420. In the centralized SON 400 of FIG. 4A, each of OAM nodes 410-1 and 410-2, and centralized OAM node 420, may execute SON functionality 430. OAM nodes 410-1 and 420-2, and centralized OAM node 420, may additionally execute network management/administration functions that provide network fault indication, fault localization, network performance, and network analysis and diagnosis functions. SON functionality 430 may perform various different types of SON sub-functions based on the data provided by the network management/administration functions of centralized OAM node 420 and/or OAM nodes 410.

Exemplary sub-functions of SON 430 may include, for example, a self-configuration sub-function, a self-optimization sub-function, a self-healing sub-function, and/or a self-protection sub-function, for automatically organizing and operating the components of the wireless network. The self-configuration sub-function may automatically configure and integrate new wireless stations 100 into the wireless network. The self-configuration sub-function may automatically adjust technical parameters, such as emission power, antenna orientation, etc., of wireless stations 100 based on changes in the network configuration (e.g., addition of a new wireless station 100, addition of a new DU 115, and failure of a DU 115 or RU 110) so as to provide a certain coverage and capacity. The self-optimization sub-function may automatically adjust wireless station 100 parameters to optimize performance of the wireless network. The self-healing sub-function may automatically identify failing network nodes and adjust the operation of adjacent nodes so that the adjacent nodes can support the users that were supported by the failing node. The self-protection sub-function may automatically defend the nodes of the wireless network from penetration by any unauthorized user.

As shown in FIG. 4B, dSON 440 includes configurable control nodes 120, OAM nodes 410-1 and 410-2, and a centralized OAM node 420. However, in dSON 440, SON functionality 430 may be implemented at each of the configurable control nodes 120, instead of at the OAM nodes 410 or 420. Implementation of the SON functionality 430 at each of the configurable control nodes 120 enables localization of control based on network data provided by the network management/administration functions of OAM nodes 410 and/or 420.

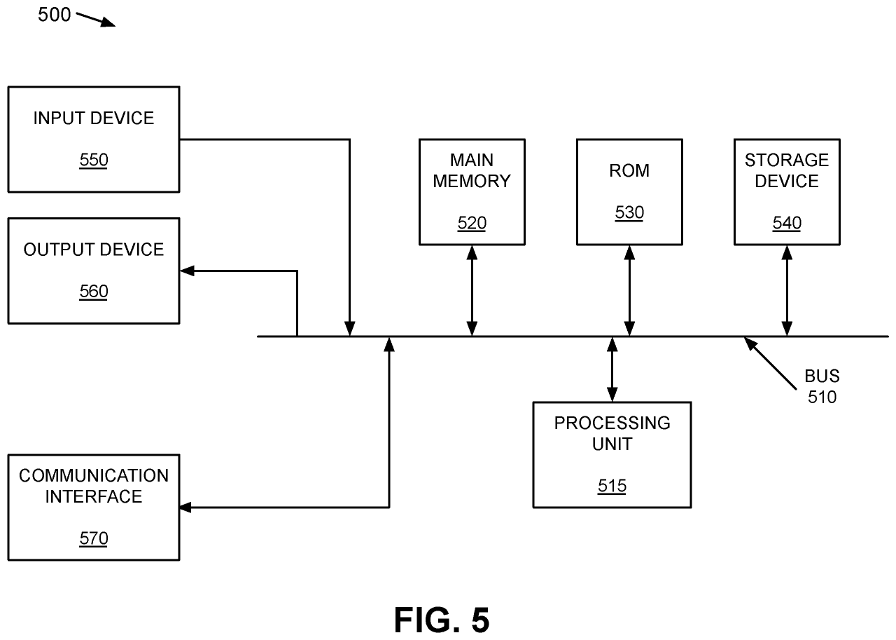

FIG. 5 is a diagram of exemplary components of a device 500. Device 500 may execute functions of a configurable control node 120, a RU 110, a DU 115, and/or other components in environment 200. Device 500 may also execute functions of C-RAN hub 230, or the data center(s) or device(s) of edge cloud 220. Device 500 may further execute core network functions (e.g., AMF, SMF, etc.) of core cloud 210.

Device 500 may include a bus 510, a processing unit 515, a main memory 520, a read only memory (ROM) 530, a storage device 540, an input device 550, an output device 560, and a communication interface 570. Bus 510 may include a path that permits communication among the elements of device 500.

Processing unit 515 may include one or more processors or microprocessors which may interpret or execute stored instructions associated with one or more processes, or processing logic that implements the one or more processes. For example, in one implementation, processing unit 515 may include, but is not limited to, programmable logic such as Field Programmable Gate Arrays (FPGAs) or accelerators. Processing unit 515 may include software, hardware, or a combination of software and hardware for executing the processes described herein. Main memory 520 may include a random access memory (RAM) or another type of dynamic storage device that may store information and, in some implementations, instructions for execution by processing unit 515. ROM 530 may include a Read Only Memory (ROM) device or another type of static storage device (e.g., Electrically Erasable Programmable ROM (EEPROM)) that may store static information and, in some implementations, instructions for use by processing unit 515. Storage device 540 may include a magnetic and/or optical recording medium and its corresponding drive. Main memory 520, ROM 530 and storage device 540 may each be referred to herein as a “non-transitory computer-readable medium” or a “non-transitory storage medium.”

Input device 550 may include one or more devices that permit a user or operator to input information to device 500, such as, for example, a keypad or a keyboard, a display with a touch sensitive panel, voice recognition and/or biometric mechanisms, etc. Output device 560 may include one or more devices that output information to the operator or user, including a display, a speaker, etc. Input device 560 and output device 560 may, in some implementations, be implemented as a graphical user interface (GUI) that displays GUI information, and which receives user input via the GUI. In some implementations, such as when device 500 executes functions of a CCN 120, input device 550 and/or output device 560 may be omitted from device 500.

Communication interface 570 may include one or more transceivers that enable device 500 to communicate with other devices and/or systems. For example, in the case where device 500 hosts the functions of a DU 115 or CCN 120, communication interface 570 may include a wired transceiver for communicating with other nodes via a wired network, such as, for example, via edge cloud 220, core cloud 210, or PDN 240. In implementations in which network device 500 executes the functions of a DU 115, communication interface 570 may include one or more optical transceivers for communicating with a RU 110 via optical fiber.

Device 500 may perform certain operations or processes, as may be described herein. Device 500 may perform these operations in response to processing unit 515 executing software instructions contained in a computer-readable medium, such as memory 520. A computer-readable medium may be defined as a physical or logical memory device. A logical memory device may include memory space within a single physical memory device or spread across multiple physical memory devices. The software instructions may be read into main memory 520 from another computer-readable medium, such as storage device 540, or from another device via communication interface(s) 570. The software instructions contained in main memory 520 may cause processing unit 515 to perform the operations or processes, as described herein. Alternatively, hardwired circuitry (e.g., logic hardware) may be used in place of, or in combination with, software instructions to implement the operations or processes, as described herein. Thus, exemplary implementations are not limited to any specific combination of hardware circuitry and software.

The configuration of components of device 500 illustrated in FIG. 5 is for illustrative purposes only. Other configurations may be implemented. Therefore, device 500 may include additional, fewer and/or different components, arranged in a different configuration, than depicted in FIG. 5.

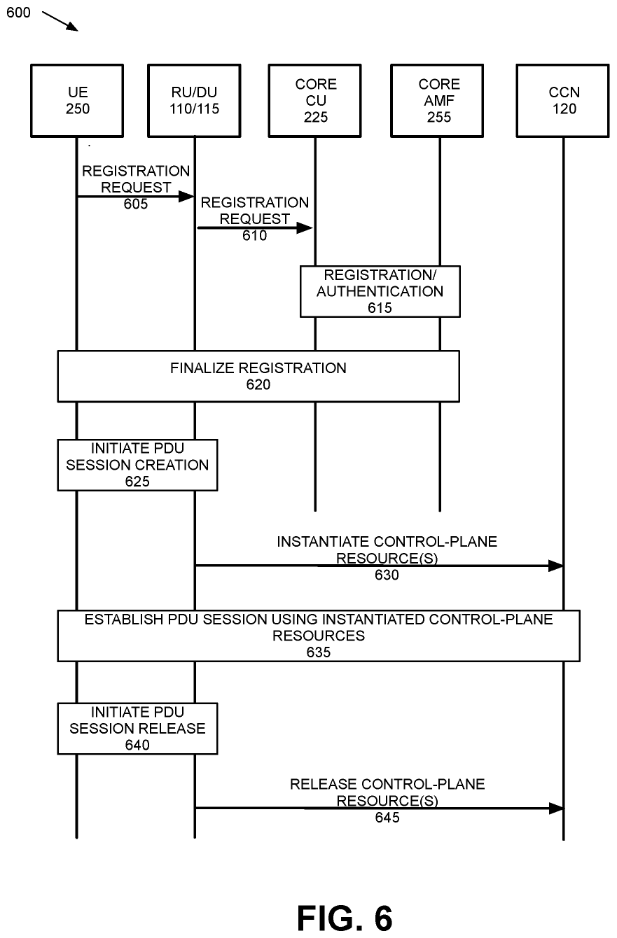

FIG. 6 shows a signal flow diagram 600 of exemplary communications between components of network environment 200. It should be understood that the signaling depicted in FIG. 6 is abbreviated to highlight concepts described herein and that, in practice, signals/messages in addition to those shown in FIG. 6 may be exchanged between network functions. As shown, UE device 250 sends registration request to RU 110/DU 115 (signal 605), which then forwards the registration request to the core CU 225 (signal 610). Core CU 225 may initiate an AMF selection process and, using the selected core AMF 255, core CU 225 and core AMF 255 may perform initial registration and authentication processing (signal 615). For example, core AMF 255 may select an appropriate AUSF (not shown in FIG. 2) and may authenticate the registration request from UE 250 using the selected AUSF.

Following authentication, core AMF 255 may initiate policy lookup and enforcement using PCF 270 (not shown in FIG. 6). Assuming that an affirmative policy decision is received by core AMF 255 (for the purposes of FIG. 6), core AMF 255, core CU 225, RU 110/DU 115 and UE 110 finalize registration of UE 110 at the core network 210 (signal 620).

Once registered, applications running on UE may initiate a data session with RU 110/DU 115 (signal 625). In a traditional network environment, such a PDU session creation process may include, among other things, selection of a suitable core SMF 260 by core AMF 255 and selection of a suitable core PCF 270. Furthermore, consistent with implementations described herein, PDU session creation may include instantiation of suitable control plane resources on one or more configurable control nodes 120 (signal 630).

For example, upon receipt of a PDU session creation request that identifies a particular type of session (e.g., low latency, ultra-low latency, high security, high reliability, etc.), DU 115 may initially determine whether one or more associated configurable control nodes 120 have available resources for hosting such functionalities. For example, DU 115 may maintain a table of instantiated resources and may determine whether a previously instantiated resource is appropriate for a particular PDU session creation request, or whether a new instance of such resource should be created.

If no resource is available, DU 115 may initiate a PDU session creation with core CU 225 and other core network elements (e.g., core AMF 255, etc.). However, if resources at one or more configurable control nodes 120 are available, DU 115 may initiate an instantiation of appropriate network functionalities within one or more configurable control node(s) 120. Using the example of FIG. 2, DU 115-2 may transmit a NAS message to CCN 120-2 that triggers instantiation of one or more of CU functionalities, AMF functionalities, and SMF functionalities. In response to the message, manager 370 may instantiate CU functionalities using CU-CP logic 305, AMF functionalities using AMF logic 310, and/or SMF functionalities using SMF logic 315. Consistent with embodiments described herein, components of CCN 120-2 may communicate, as necessary with other functional components in core cloud 210 or edge cloud 220 to retrieve or update information necessary to establish the request functions or functional features. For example, AMF logic 310 may retrieve information from core AMF 255, etc. In other embodiments, manager 370 may maintain and/or update instantiation configuration information for use during component instantiation.

In some embodiments, the instantiated functionalities are configured to perform a subset of the functions that may be performed by the corresponding core network counterpart functions. For example, while core AMF may support lawful intercept functions or non-3GPP access connection, the AMF functionalities instantiated at CCN 120 may remove or limit this support to increase performance and reduce resource utilization at CCN 120. In any event, once the necessary resources have been instantiated/allocated, PDU session creation may be performed using the instantiated network components (signal 635).

When the UE application no longer requires the session, UE 250 may transmit a PDU session release message to RU 110/DU 115 to initiate the session release (signal 640). In response, DU 115 may release any previously instantiated functionalities, at configurable control node(s) 120, corresponding to the particular application (signal 645). In some implementations, DU 115 may first ascertain whether other application instances at either UE 250, or other UEs (250) are also using the instantiated resources. If so, the PDU session may be released, but the instantiated functionalities may be maintained.

By providing for a configurable control nodes at locations closer to UEs than corresponding core network components, configurable control nodes may allow UEs to experience increased network performance and improved security, while simultaneously maintaining flexibility in network architecture implementation.

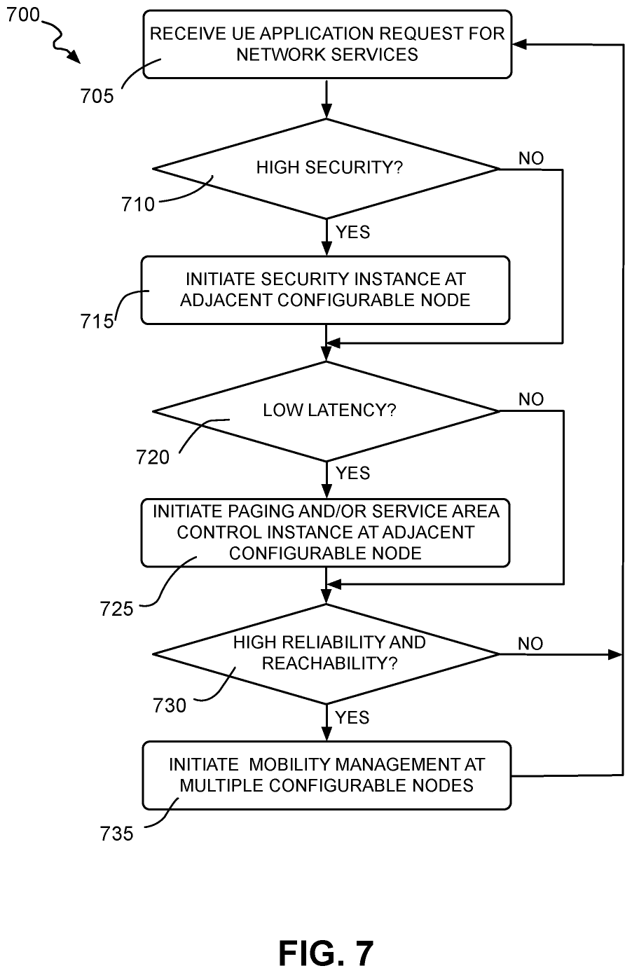

FIG. 7 is a flow diagram of an exemplary process 700 for dynamically configuring network control plane functions based on, for example, network performance requirements of a particular UE application. Process 700 may be implemented by a DU 115, although in other embodiments, other components may perform one or more portions of process 700.

As shown, process 700 includes receiving a UE application request for network services (block 705). For example, DU 115 may receive (from UE 250 via RU 110) a PDU session creation request indicating a particular type of connection having particular control plane requirements. In response to the request, it is determined whether the request identifies high security requirements (block 710). If not (block 710—NO), the process continues to block 720 described below. However, if the request identifies one or more high security requirements (block 710—YES), instantiation of a security instance may be initiated at an adjacent (or relatively adjacent) configurable control node 120. For example, DU 115 may transmit a message to CCN 120 requesting an instantiation of one or more security-related functionalities. In response, manager 370 of CCN 120 may, using CU-CP logic 305, AMF logic 310, and/or SMF logic 315, instantiate appropriate instances of security related functionalities in CCN 120.

At block 720, it is determined whether the request identifies low or ultra low latency requirements. If not (block 720—NO), the process continues to block 730 described below. However, if the request identifies one or more low latency requirements (block 720—YES), instantiation of a paging and area control instance may be initiated at an adjacent (or relatively adjacent) configurable control node 120 (block 725). For example, DU 115 may transmit a message to CCN 120 requesting an instantiation of one or more paging or tracking area-related functionalities. In response, manager 370 of CCN 120 may, using CU-CP logic 305 and/or AMF logic 310, instantiate appropriate instances of paging and tracking area control functionalities in CCN 120.

At block 730, it is determined whether the request identifies high reliability or reachability requirements. If not (block 730—NO), the process returns to block 705 for a next network services (e.g., PDU session) request. However, if the request identifies one or more high reliability or reachability requirements (block 730—YES), instantiation of mobility management instances may be initiated at a plurality of proximate configurable control nodes 120 (block 735). For example, DU 115 may transmit a message to a number of proximate CCNs 120 requesting the instantiation of one or more mobility management-related functionalities. In response, managers 370 of the receiving CCNs 120 may, using CU-CP logic 305, AMF logic 310, and or SMF logic 315 instantiate appropriate instances of mobility management-related functionalities in CCN 120.

The foregoing description of implementations provides illustration and description but is not intended to be exhaustive or to limit the invention to the precise form disclosed. Modifications and variations are possible in light of the above teachings or may be acquired from practice of the invention. For example, while a series of blocks has been described with respect to FIG. 7, the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims. No claim element of a claim is to be interpreted under 35 U.S.C. § 112(f) unless the claim element expressly includes the phrase “means for” or “step for.”

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, by a network device, a message requesting establishment of a packet data unit (PDU) session for an end device;
determining, by the network device, that the message identifies particular performance requirements relating to the requested PDU session;
initiating dynamic instantiation of one or more functionalities at a configurable control node based on the particular performance requirements;
wherein the one or more functionalities comprise one or more of: centralized unit (CU) functionalities, accessibility and mobility management function (AMF) functionalities, or session management function (SMF) functionalities; and
establishing the PDU session using one or more of the dynamically instantiated functionalities.

2. The method of claim 1, wherein the performance requirements indicate one or more of:
a security requirement, a latency requirement, and a reliability or reachability requirement.

3. (canceled)

4. The method of claim 1, wherein initiating the dynamic instantiation further comprises:
determining available resources at the configurable control node; and
initiating the dynamic instantiation when the available resources at the configurable control node can accommodate the one or more functionalities.

5. The method of claim 1, further comprising:
receiving a request to release the PDU session;
releasing the PDU session based on the release request; and
deallocating resources associated with the dynamically instantiated one or more functionalities based on the release request.

6. The method of claim 5, further comprising:
determining whether one or more of the dynamically instantiated functionalities are in use by another PDU session; and
not deallocating resources corresponding to the one or more of the dynamically instantiated functionalities that are in use by the other PDU session.

7. The method of claim 1, further comprising:
receiving a registration request message from the end device;
forwarding the registration request message to a centralized unit in one of a core network or an edge network,
wherein the centralized unit communicates with one or more of an access and mobility management function (AMF) and a session management function (SMF) in the core or edge network;
finalizing the registration with the centralized unit; and
receiving the message requesting establishment of PDU session following the registration.

8. The method of claim 1, wherein the network device comprises a distributed unit (DU) of a wireless station.

9. A device, comprising:
at least one communication interface; and
one or more processors configured to:
receive a message requesting establishment of a packet data unit (PDU) session for an end device;
determine that the message identifies particular performance requirements relating to the requested PDU session;
initiate dynamic instantiation of one or more functionalities at a configurable control node based on the particular performance requirements,
wherein the one or more functionalities comprise one or more of:
centralized unit (CU) functionalities, accessibility and mobility management function (AMF) functionalities, or session management function (SMF) functionalities; and
establish the PDU session using one or more of the dynamically instantiated functionalities.

10. The device of claim 9, wherein the performance requirements indicate one or more of:
a security requirement, a latency requirement, and a reliability or reachability requirement.

11. (canceled)

12. The device of claim 9, wherein the one or more processors, to initiate the dynamic instantiation are further configured to:
determine available resources at the configurable control node; and
initiate the dynamic instantiation when the available resources at the configurable control node can accommodate the one or more functionalities.

13. The device of claim 9, wherein the one or more processors, are further configured to:
receive a request to release the PDU session;
release the PDU session based on the release request; and
initiate deallocation of resources associated with the dynamically instantiated functionalities based on the release request.

14. The device of claim 13, wherein the one or more processors, are further configured to:
determine whether one or more of the dynamically instantiated functionalities are in use by another PDU session; and
not initiate the deallocation of resources corresponding to the one or more of the dynamically instantiated functionalities that are in use by the other PDU session.

15. The device of claim 9, wherein the one or more processors, are further configured to:
receive a registration request message from an end device;
forward the registration request message to a centralized unit in one of a core network or an edge network,
wherein the centralized unit communicates with one or more of an access and mobility management function (AMF) and a session management function (SMF) in the core or edge network;
finalize the registration with the centralized unit; and
receive the message requesting establishment of PDU session following the registration.

16. The device of claim 9, wherein the device comprises a distributed unit (DU) of a wireless station.

17. A non-transitory storage medium storing instructions executable by a device, wherein the instructions cause the device to:
receive, by a network device, a message requesting establishment of a packet data unit (PDU) session for an end device;
determine, by the network device, that the message identifies particular performance requirements relating to the requested PDU session;
initiate dynamic instantiation of one or more functionalities at a configurable control node based on the particular performance requirements,
wherein the one or more functionalities comprise one or more of: centralized unit (CU) functionalities, accessibility and mobility management function (AMF) functionalities, or session management function (SMF) functionalities; and
establish the PDU session using one or more of the dynamically instantiated functionalities.

18. The non-transitory storage medium of claim 17, wherein the particular performance requirements indicate one or more of:
a security requirement, a latency requirement, and a reliability or reachability requirement.

19. (canceled)

20. The non-transitory storage medium of claim 17, wherein the instructions cause the device to initiate the dynamic instantiation further cause the device to:
determine available resources at the configurable control node; and
initiate the dynamic instantiation when the available resources at the configurable control node can accommodate the one or more functionalities.
